(19) United States
(12) Patent Application Publication
(10) Pub. No.: US 2023/0295036 A1
(43) Pub. Date: Sep. 21, 2023

(54) GLASS SUBSTRATE HAVING THROUGH HOLES

(71) Applicant: NIPPON ELECTRIC GLASS CO., LTD., Otsu-shi, Shiga (JP)

(72) Inventor: Masaki MAKITA, Otsu-shi, Shiga (JP)

(73) Assignee: NIPPON ELECTRIC GLASS CO., LTD., Otsu-shi, Shiga (JP)

(21) Appl. No.: 18/022,185

(22) PCT Filed: Sep. 22, 2021
(86) PCT No.: PCT/JP2021/034851

§ 371 Date: Feb. 20, 2023

(30) Foreign Application Priority Data
Oct. 6, 2020 (JP) 2020-169059

(51) Int. Cl. C03C 23/00; C03C 15/00; C03C 3/083; C03C 3/085; C03C 3/087; C03C 3/091

(52) U.S. Cl. CPC C03C 23/0025; C03C 15/00; C03C 3/083; C03C 3/085; C03C 3/087; C03C 3/091

(57) ABSTRACT

The glass substrate has a substrate thickness of from 0.10 mm to 0.50 mm and has two or more through holes, a taper angle of the through holes being from 0° to 13°, and a shortest distance among center-to-center distances between the through holes being 200 μm or less.

### TECHNICAL FIELD

The present invention relates to a glass substrate having through holes.

### BACKGROUND ART

Examples of an application of a glass substrate having through holes include a glass interposer (Patent Document 1) and a micro-LED display (Patent Document 2). The smaller the hole diameter of through holes at the glass surface, the more densely the through holes can be made, allowing semiconductors to be mounted on the glass substrate at a high density.

A first method of manufacturing a glass plate having through holes is a method of irradiating a glass plate with a laser beam to form through holes (Patent Document 3). Furthermore, a second method of manufacturing a glass plate having through holes is a method of first forming initial through holes with laser and then enlarging the hole diameter by etching (Patent Document 4). However, in the first method and the second method, the through holes are formed by thermal processing using laser, which may lead to issues such as cracks generated in the glass.

In response to that, a third method of manufacturing a glass plate having through holes is a method of forming through holes by first making modified portions by irradiating a laser beam and then subsequently removing the modified portions by etching (Patent Document 5). Ultra-short pulse laser is used to make the modified portions, and as such, the effect from heat can be minimized, and the issues described above do not occur. Meanwhile, when using the third method to make through holes, the through holes have a tapered shape. It is important to reduce the taper angle of the through holes in order to make through holes at a high density; to this end, for example, the addition of a coloring element to glass has been proposed (Patent Document 6).

### CITATION LIST

### Patent Literature

Patent Document 1: JP 2015-146401 A
Patent Document 2: JP 2020-522884 A
Patent Document 3: JP 2016-55295 A
Patent Document 4: JP 5994954 B
Patent Document 5: JP 6333282 B
Patent Document 6: JP 6700201 B

### SUMMARY OF INVENTION

### Technical Problem

However, when a glass substrate is used in a display application, the film formation step and the like at panel manufacturers are optimized for glass substrates for displays currently in use. For this reason, it is difficult to change the physical, chemical, and optical properties of known glass substrates. In particular, the transmittance in the visible range of glass substrates needs to be high. In other words, it is practically difficult to change glass compositions by adding a coloring element, for example.

An object of the present invention is to provide a glass substrate that has through holes with a small taper angle and is suitable for display applications.

### Solution to Problem

A glass substrate according to an embodiment of the present invention is a glass substrate having a substrate thickness of from 0.10 mm to 0.50 mm and having two or more through holes, the through holes having a taper angle of from 0° to 13° and a shortest distance among center-to-center distances between the through holes being 200 μm or less.

In the glass substrate according to an embodiment of the present invention, the shortest distance among the center-to-center distances between the through holes is preferably greater than 1.2 times a sum of radii of two through holes with the shortest center-to-center distance.

The glass substrate according to an embodiment of the present invention preferably includes at least one through hole having a hole diameter of from 1 μm to 100 μm.

The glass substrate according to an embodiment of the present invention preferably includes 0 mol % or greater and less than 0.2 mol % of TiO₂, 0 mol % or greater and less than 0.2 mol % of CuO, and 0 mol % or greater and less than 5 mol % of ZnO as glass composition.

The glass substrate according to an embodiment of the present invention is preferably a low-alkali glass. Here, “a low-alkali glass” means a glass in which a total amount of Li₂O, Na₂O and K₂O is less than 1.0%.

The glass substrate according to an embodiment of the present invention preferably includes from 50 to 80 mol % of SiO₂, from 1 to 20 mol % of Al₂O₃, from 0 to 20 mol % of B₂O₃, from 0 to 1.0 mol % of Li₂O+Na₂O+K₂O, from 0 to 15 mol % of MgO, from 0 to 15 mol % of CaO, from 0 to 15 mol % of SrO, from 0 to 15 mol % of BaO, 0 mol % or greater and less than 0.050 mol % of As₂O₃, and 0 mol % or greater and less than 0.050 mol % of Sb₂O₃ as glass composition. Here, “Li₂O+Na₂O+K₂O” means the total amount of Li₂O, Na₂O, and K₂O.

A method for manufacturing the glass substrate according to an embodiment of the present invention includes: forming two or more modified portions on a glass substrate using laser irradiation, and then removing the modified portions by etching, in a manner that a substrate thickness of the glass substrate is reduced by from 1 to 100 μm, to form two or more through holes having a taper angle of from 0° to 13°.

Another method for manufacturing the glass substrate according to an embodiment of the present invention includes: forming two or more modified portions on a glass substrate using laser irradiation, and then removing the modified portions by etching, in a manner that the glass substrate has: (amount of substrate thickness reduced by etching)/(substrate thickness before etching) of 0.200 or less, to form two or more through holes having a taper angle of from 0° to 13°. Note that “(amount of substrate thickness reduced by etching)/(substrate thickness before etching)” is a value obtained by dividing the (amount of substrate thickness reduced by etching) by the (substrate thickness before etching).

### Advantageous Effects of Invention

According to the present invention, a glass substrate that has through holes with a small taper angle and is suitable for display applications can be provided.

### BRIEF DESCRIPTION OF DRAWINGS

FIG. 1 is a schematic plan view of a glass substrate having modified portions;

FIG. 2 is a schematic cross-sectional view of a glass substrate having a modified portion;

FIG. 3 is a schematic cross-sectional view of a glass substrate during etching;

FIG. 4 is a schematic cross-sectional view of a glass substrate immediately after a through hole is formed;

FIG. 5 is a schematic cross-sectional view of a glass substrate having a thickness of tB1;

FIG. 6 is a schematic cross-sectional view of a glass substrate having a thickness of tB2;

FIG. 7 is a schematic cross-sectional view of a glass substrate having a thickness of tA1 and a through hole;

FIG. 8 is a schematic cross-sectional view of a glass substrate having a thickness of tA2 and a through hole;

FIG. 9 is a schematic plan view of a glass substrate in which modified portions are made at a narrow pitch on a circle having a diameter of r;

FIG. 10 is a schematic cross-sectional view of a glass substrate having a narrowed portion inside a through hole;

FIG. 11 is a schematic cross-sectional view of a glass substrate in which a narrowed portion inside a through hole is not located at the center portion of a substrate thickness;

FIG. 12 is a schematic cross-sectional view of a glass substrate without a narrowed portion inside a through hole;

FIG. 13 is a schematic cross-sectional view of a glass substrate, in which a narrowed portion inside a through hole is not located at the center portion of a substrate thickness, immediately after the through hole is formed;

FIG. 14 is a diagram illustrating a relationship between a substrate thickness after etching tA and a taper angle θ of through holes in a glass substrate having through holes;

FIG. 15 is a diagram illustrating a relationship between an amount of substrate thickness reduced by etching Δt and a taper angle θ of through holes in a glass substrate; and

FIG. 16 is a diagram illustrating a relationship between a value of (amount of substrate thickness reduced by etching Δt)/(substrate thickness before etching tB) and a taper angle θ of through holes.

### DESCRIPTION OF EMBODIMENTS

Hereinafter, embodiments of the present invention will be described. It should be understood that the present invention is not limited to the following embodiments and that suitable modifications, improvements and the like added to the following embodiments on the basis of ordinary knowledge of those skilled in the art without departing from the gist of the present invention also fall in the scope of the present invention.

A glass substrate according to an embodiment of the present invention and a method for manufacturing the glass substrate will be described with reference to drawings. In the present specification, a numerical range expressed using “from” and “to” refers to a range including the numerical value before “to” as the minimum value and the numerical value after “to” as the maximum value.

Modified Portion

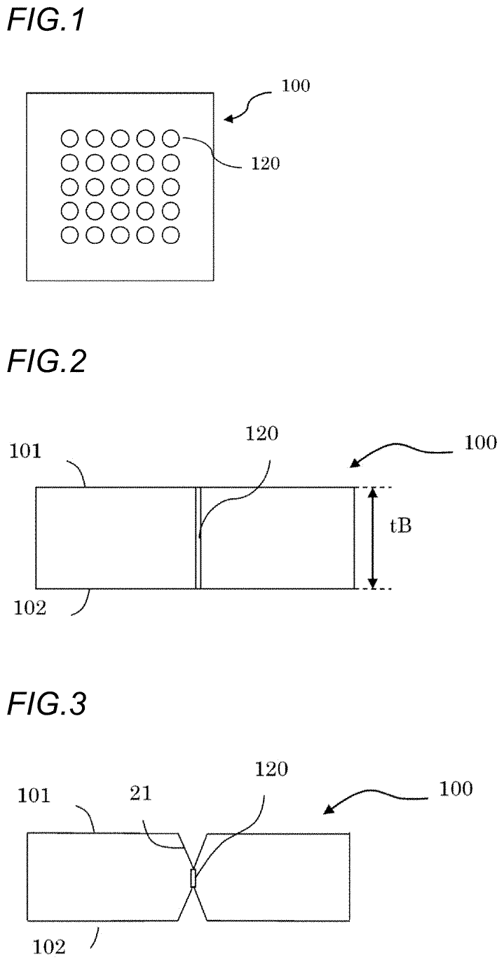

FIG. 1 is a schematic plan view of a glass substrate having modified portions formed therein. FIG. 2 is a schematic cross-sectional view of a glass substrate having a modified portion formed therein. Two or more modified portions 120 can be formed by irradiating a glass substrate 100 with femtosecond or picosecond pulsed laser. The modified portions formed in the glass can be confirmed as, for example, regions having a different refractive index when the glass is observed from the cross-sectional direction using an optical microscope. Also, a diameter of the modified portions to be made is preferably approximately from 1 to 5 μm.

Note that a beam shape of a laser used to make the modified portions is not limited, and for example, a Gaussian beam shape or a Bessel beam shape can be adopted. Of these, the Bessel beam shape is preferable. By setting the beam shape of the laser to be the Bessel beam shape, the modified portions 120 can be formed penetrating the glass substrate along the substrate thickness direction in one shot, and the time required to make the modified portions can be shortened. The Bessel beam shape can be formed, for example, by using an axicon lens.

Through Hole

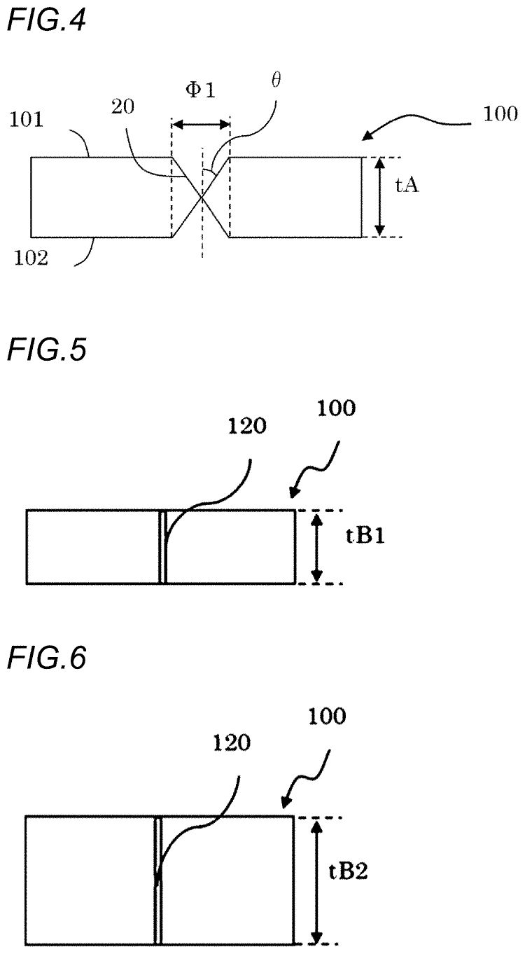

FIG. 2 is a schematic cross-sectional view illustrating a glass substrate having a modified portion formed therein. FIG. 3 is a schematic cross-sectional view illustrating a glass substrate during etching. FIG. 4 is a schematic cross-sectional view illustrating a glass substrate immediately after a through hole is formed. Note that, although one modified portion 120 and one through hole 20 are illustrated for explanation, two or more modified portions 120 and two or more through holes 20 are actually provided.

On the glass substrate 100 having a thickness tB and having modified portions 120 formed penetrating the glass substrate 100 along the substrate thickness direction, etching is performed on both a first surface 101 and on a second surface 102 opposite to the first surface 101. As illustrated in FIG. 3, during etching, a modified portion 120 that has not yet been removed exists between a non-through hole 21 extending from the first surface 101 and another non-through hole 21 extending from the second surface 102. As the etching proceeds further, as illustrated in FIG. 4, the hole extending from the first surface 101 and the hole extending from the second surface 102 are connected, forming the through hole 20.

A glass substrate thickness is reduced from tB to tA by etching, and the modified portions 120 are removed, forming the through holes 20. The through holes 20 have a tapered shape, and a taper angle θ of the through holes 20 can be calculated based on Equation 1 below using a hole diameter Φ1 at the first surface 101 and the second surface 102 and using the substrate thickness tA.

θ=arctan(Φ1/tA) Equation 1

The type of an etching liquid used for etching is not limited as long as the etching liquid has a higher etch rate for the modified portions 120 than for the glass substrate 100, and for example, a HF aqueous solution or a KOH aqueous solution can be used. The etching liquid is preferably a HF aqueous solution for its high etch rate, making it possible to shorten the time required to form the through holes. Alternatively, the etching liquid may be a mixed solution in which one or a plurality of types of acids selected from HCl, H₂SO₄, HNO₃, and the like is added to the HF aqueous solution.

A temperature of the etching liquid is not limited, but a high temperature is effective. In a case in which the etching liquid includes HF, a temperature range is preferably from 0 to 50° C., more preferably from 20 to 40° C., even more preferably from 25 to 40° C., and particularly preferably from 30 to 35° C. When the temperature of the etching liquid is set to a high temperature, a reduction speed of substrate thickness and a removal speed of modified portions increase, and the rate at which the removal speed of modified portions increases becomes greater than the rate at which the reduction speed of substrate thickness increases. That is, when the temperature of the etching liquid is set to a high temperature, the taper angle of the through holes can be reduced, the time required to make the through holes can be shortened, and the amount of substrate thickness reduced becomes small. Meanwhile, when the temperature of the etching liquid is too high, the HF volatilizes and the concentration of HF in the etching liquid becomes uneven, resulting in a large variation in the hole shape. In particular, when ultrasonic waves are applied during etching as will be described later, the temperature of the etching liquid is likely to rise locally, and volatilization of HF is likely to occur.

During etching of the glass substrate 100, stirring or ultrasonic waves are preferably applied to the etching liquid. In particular, by applying ultrasonic waves, adhesion and re-deposition of residue on the inner hole walls during the course of making the through holes can be suppressed. A frequency of the ultrasonic waves is preferably 100 kHz or less, more preferably 45 kHz or less, and particularly preferably 30 kHz or less. In such a range of frequency, the effect of ultrasonic cavitation can be enhanced.

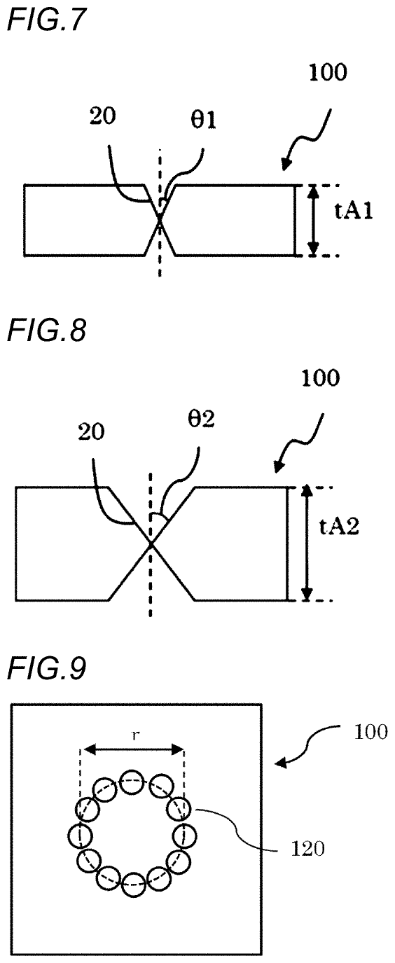

FIG. 5 is a schematic cross-sectional view illustrating a glass substrate having a thickness of tB1. FIG. 6 is a schematic cross-sectional view illustrating a glass substrate having a thickness of tB2. FIG. 7 is a schematic cross-sectional view illustrating a glass substrate having a thickness of tA1 immediately after a through hole is formed therein. FIG. 8 is a schematic cross-sectional view illustrating a glass substrate having a thickness of tA2 immediately after a through hole is formed therein. When the glass substrate illustrated in FIG. 5 is etched until a through hole is formed, the glass substrate having a through hole illustrated in FIG. 7 can be obtained. When the glass substrate illustrated in FIG. 6 is etched until a through hole is formed, the glass substrate having a through hole illustrated in FIG. 8 can be obtained. If tB1<tB2, then tA1<tA2 and θ1<θ2. This means that by reducing an original substrate thickness of the glass substrate, the taper angle when the through holes are formed can be reduced. As an inferred mechanism, for example, when the original substrate thickness of the glass substrate is reduced, the amount of substrate thickness reduced when etching the glass substrate until the through holes are formed becomes small, and the amount of residue generated is reduced; as such, a decrease in the removal speed of modified portions due to deposition of residue on the inside of holes is suppressed. In addition to this mechanism, another inferred mechanism describes that, for example, when the original substrate thickness of the glass substrate is reduced, a hole depth becomes small, making it easier to remove residue inside the holes; as such, a decrease in the removal speed of modified portions during etching is suppressed.

Note that, in a case in which etching of the glass substrate is continued in order to expand the hole diameter of the through holes, the resulting residue stays in a narrowed portion of the through holes, and the enlargement speed of hole diameter at the narrowed portion decreases, increasing the taper angle of the through holes. This can be solved by, for example, making the modified portions 120 at a narrow pitch on a circle having a diameter r as illustrated in FIG. 9. Such modified portions can be made by laser-scanning using a galvano scanner, or by performing laser irradiation while scanning a stage, on which the glass substrate is placed, along a circle having a diameter r. When the glass substrate in which the modified portions are formed in this manner is etched, the through holes formed from the modified portions are connected with each other, and as such, the resulting through hole has a diameter as large as r, which is the diameter of the circle, while the taper angle is maintained at the taper angle of the through hole immediately after the formation of the through hole. Therefore, the most important thing is to reduce the taper angle of the through holes immediately after the formation of the through holes. Additionally, to ensure the removal of glass during the formation of the through holes, the modified portions may be formed in a manner that the modified portions fill the interior of the circle having a diameter r.

By reducing the substrate thickness of the glass substrate before the through holes are formed or by reducing the substrate thickness of the glass substrate after the through holes are formed as described above, even glass substrates that could not be used thus far due to their large taper angles may be used by being subjected to substrate thickness reduction. In particular, the substrate thickness reduction allows a glass substrate that has been used in a display application thus far to be used as a glass substrate having through holes for mini-LED display or micro-LED display applications.

The substrate thickness of the glass substrate having through holes is preferably 0.50 mm or less, 0.48 mm or less, 0.46 mm or less, 0.44 mm or less, 0.40 mm or less, 0.38 mm or less, 0.37 mm or less, 0.35 mm or less, 0.34 mm or less, 0.32 mm or less, 0.31 mm or less, 0.30 mm or less, 0.29 mm or less, 0.28 mm or less, 0.27 mm or less, 0.26 mm or less, or 0.25 mm or less, and particularly preferably 0.24 mm or less. When the substrate thickness of the glass substrate having through holes is set to within such a range, the taper angle of the through holes can be reduced, and the through holes can be made at a high density. Further, the substrate thickness of the glass substrate having through holes is preferably 0.10 mm or greater, 0.11 mm or greater, 0.13 mm or greater, 0.15 mm or greater, 0.16 mm or greater, 0.18 mm or greater, or 0.20 mm or greater, and particularly preferably greater than 0.20 mm. When the substrate thickness of the glass substrate having through holes is set to within such a range, an amount of deflection of the glass substrate that occurs when a circuit portion is made on the glass substrate having through holes can be reduced, suppressing both pattern deviation caused by deflection and damage to the glass substrate.

A substrate thickness of glass substrate before etching is preferably 0.70 mm or less, 0.60 mm or less, 0.50 mm or less, 0.48 mm or less, 0.45 mm or less, 0.43 mm or less, 0.40 mm or less, 0.39 mm or less, 0.37 mm or less, 0.35 mm or less, 0.34 mm or less, 0.32 mm or less, 0.30 mm or less, 0.28 mm or less, or 0.26 mm or less, and particularly preferably 0.25 mm or less. When the substrate thickness of glass substrate before etching is set to within this range, the taper angle of the through holes can be reduced as described above. Further, the substrate thickness of glass substrate before etching is preferably 0.10 mm or greater, 0.12 mm or greater, 0.13 mm or greater, 0.15 mm or greater, 0.16 mm or greater, 0.17 mm or greater, 0.18 mm or greater, or 0.20 mm or greater, and particularly preferably greater than 0.20 mm. When the substrate thickness is less than 0.10 mm, the glass substrate is prone to damage when the glass substrate is being placed into an etching tank or when the glass substrate is being removed from the etching tank.

When the glass substrate is used in a display application, the taper angle of the through holes is preferably 130 or less, 110 or less, 9.4° or less, 9.10 or less, 9° or less, 8.5° or less, 8.0° or less, 7.5° or less, 7.4° or less, 7.3° or less, 7.0° or less, 6.9° or less, 6.8° or less, 6.7° or less, 6.6° or less, 6.5° or less, 6.4° or less, 6.3° or less, 6.2° or less, 6.10 or less, 6.0° or less, 5.9° or less, 5.7° or less, or 5.5° or less, and particularly preferably 5.3° or less. When the taper angle of the through holes is set to within such a range, the hole diameter at the glass surface can be reduced, and the through holes can be made at a high density. Further, the taper angle of the through holes is preferably 0° or greater, 10 or greater, 1.5° or greater, 2° or greater, 3° or greater, 3.10 or greater, 3.2° or greater, 3.3° or greater, 3.4° or greater, 3.5° or greater, 3.6° or greater, 3.7° or greater, 3.8° or greater, 3.9° or greater, 4° or greater, 4.10 or greater, 4.3° or greater, 4.5° or greater, 4.7° or greater, or 4.9° or greater, and particularly preferably 5° or greater. After the through holes are formed, a plating step is required for forming a conductive portion on the inner walls of the through holes in order to establish conduction between the front and back sides of the glass substrate. When the taper angle is below the range described above, it becomes difficult to form a seed layer deep in the through holes by sputtering during the plating step for the inside of the through holes, and the time required for sputtering tends to be longer.

A shortest distance among center-to-center distances between the through holes in the glass substrate having two or more through holes is preferably 200 μm or less, 160 μm or less, 100 μm or less, 80 μm or less, 60 μm or less, 50 μm or less, 45 μm or less, 40 μm or less, or 35 μm or less, and particularly preferably 30 μm or less. When the shortest distance among the center-to-center distances between the through holes is set to within such a range, the through holes can be made at a high density, and semiconductors can be mounted on the glass substrate at a high density. Further, the shortest distance among the center-to-center distances between the through holes is preferably 5 μm or greater, 10 μm or greater, 15 μm or greater, or 20 μm or greater, and particularly preferably 25 μm or greater. When the shortest distance among the center-to-center distances between the through holes is set to within such a range, sufficient space for making the circuit portion can be ensured, and the degree of freedom regarding the circuit pattern can be increased. The shortest distance among the center-to-center distances between the through holes is preferably greater than 1.2 times, greater than or equal to 1.5 times, greater than or equal to 1.7 times, greater than or equal to 2.0 times, or greater than or equal to 2.2 times, and particularly preferably greater than or equal to 2.5 times a sum of radii of two through holes with the shortest center-to-center distance. When the center-to-center distances between the through holes are below such a range, the distances between edges of the through holes at the glass surface are short, and the glass is prone to damage starting from the edges of the through holes.

A hole diameter of the through holes at the glass surface is preferably 100 μm or less, 90 μm or less, 80 μm or less, 75 μm or less, 72 μm or less, 70 μm or less, 68 μm or less, 65 μm or less, 60 μm or less, 50 μm or less, 45 μm or less, 40 μm or less, 38 μm or less, 35 μm or less, 30 μm or less, 29 μm or less, 26 μm or less, 25 μm or less, or 23 μm or less, and particularly preferably 20 μm or less. When the hole diameter of the through holes at the glass surface is set to within such a range, the through holes can be made at a high density, and semiconductors can be mounted on the glass substrate at a high density. Further, the hole diameter of the through holes at the glass surface is preferably 1 μm or greater, 5 μm or greater, 10 μm or greater, or 13 μm or greater, and particularly preferably 15 mm or greater. When the hole diameter of the through holes at the glass surface is set to within such a range, a plating liquid easily permeates the inside of the through holes, and the reliability of plating inside the through holes is increased.

A surface roughness Sa of the glass substrate having through holes is preferably 5.000 nm or less, 1.000 nm or less, 0.800 nm or less, 0.700 nm or less, or 0.600 nm or less, and particularly preferably 0.500 nm or less. When the surface roughness Sa of the glass substrate having through holes is set to within this range, reliability is increased when TFTs are made on glass substrates to be used in a display application. Further, the surface roughness Sa of the glass substrate having through holes is preferably 0.050 nm or greater, 0.075 nm or greater, 0.100 nm or greater, or 0.125 nm or greater, and particularly preferably 0.150 nm or greater. When the surface roughness Sa of the glass substrate having through holes is set to within this range, during a process of making a plated film at the surface of the glass substrate in order to make a circuit portion on the glass substrate, the adhesion of the plated film to the glass substrate is improved due to an anchoring effect.

When the glass substrate is being etched, a residue commensurate with the amount of substrate thickness reduced is generated, but at this time, the residue re-deposits on the inside of the holes that are being made. As a result, the etch rate in the modified portions along the depth direction decreases, and the taper angle increases. Therefore, in order to make through holes having a small taper angle, the amount of substrate thickness reduced by etching needs to be small. As such, the amount of substrate thickness reduced by etching is preferably 100 μm or less, 90 μm or less, 85 μm or less, 80 μm or less, 75 μm or less, less than 70 μm, less than 65 μm, 64 μm or less, 60 μm or less, 57 μm or less, 50 μm or less, 45 μm or less, 40 μm or less, 35 μm or less, 31 μm or less, 30 μm or less, or 20 μm or less, and particularly preferably 15 μm or less. Furthermore, the amount of substrate thickness reduced by etching is preferably 1 μm or greater. When the amount of substrate thickness reduced by etching is within such a range, fine cracks present on the glass surface and sides can be removed, and the strength of the glass can be increased.

Moreover, a value of (amount of substrate thickness reduced by etching)/(substrate thickness before etching) is preferably 0.200 or less, 0.180 or less, 0.170 or less, 0.160 or less, 0.150 or less, 0.140 or less, 0.135 or less, 0.130 or less, 0.120 or less, or 0.110 or less, and particularly preferably 0.100 or less. When the value of (amount of substrate thickness reduced by etching)/(substrate thickness before etching) is set to within such a range, the amount of residue resulting from etching can be reduced as described above, and as a result, the taper angle of the through holes made can be reduced. Further, the value of (amount of substrate thickness reduced by etching)/(substrate thickness before etching) is preferably greater than 0, greater than or equal to 0.001, or greater than or equal to 0.003, and particularly preferably greater than or equal to 0.005. When the value of (amount of substrate thickness reduced by etching)/(substrate thickness before etching) is set to within such a range, fine cracks present on the glass surface and sides can be removed, and the strength of the glass can be increased.

With the above method and conditions, the taper angle can be reduced without changing the glass composition. As such, even a glass substrate that has a large taper angle and could not be used thus far can be used as a glass substrate having through holes.

When the glass substrate having through holes is used in a display application, a shape of the glass substrate having through holes is preferably rectangular.

In particular, when the glass substrate is used in a tiled mini-LED display or micro-LED display, the shape of the glass substrate is preferably within the following ranges. A difference between lengths of two opposing sides is preferably 100 μm or less, more preferably 80 μm or less, even more preferably 50 μm or less, and particularly preferably 30 μm or less. An angle formed by two adjacent sides at the glass surface is preferably from 89.00° to 91.00°, more preferably from 89.50° to 90.50°, even more preferably from 89.80° to 90.20°, and particularly preferably from 89.90° to 90.10°. A thickness deviation of the glass substrate is preferably 10 μm or less, more preferably 8 μm or less, and particularly preferably 5 μm or less. Also, in order to reduce damage to the glass substrate, the four corners may be chamfered. When the glass substrate is set to have such a shape, it is possible to reduce the displacement of pixel positions during tiling, and it is possible to make it difficult to recognize the boundary between tiles.

The method for manufacturing such a glass substrate may be preparing a rectangular glass substrate having the dimensions described above in advance and then making through holes in the rectangular glass substrate, or may be cutting a glass substrate with through holes made therein into a rectangular shape by, for example, laser scribing to give the glass substrate the dimensions described above. In addition, when making the modified portions for forming the through holes, separate modified portions may be made at a narrow pitch forming the rectangular shape described above. By the etching of this glass substrate, the glass substrate can be cut into the rectangular shape described above during the same time when the through holes are formed.

Glass Substrate

A type of the glass substrate is not limited, but when the glass substrate is used as a substrate glass for displays, the transmittance in the visible range of the glass substrate needs to be high, and thus a content of a coloring element is preferably small. As such, the glass substrate preferably includes 0 mol % or greater and less than 0.2 mol % of TiO₂, 0 mol % or greater and less than 0.2 mol % of CuO, and 0 mol % or greater and less than 5 mol % of ZnO as glass composition.

Also, when the glass substrate is used as a substrate glass for displays, the glass substrate is preferably a low-alkali glass in order to prevent alkali ions from diffusing into a semiconductor material deposited during a heat treatment process. As such, the glass substrate preferably includes from 50 to 80 mol % of SiO₂, from 1 to 20 mol % of Al₂O₃, from 0 to 20 mol % of B₂O₃, from 0 to 1.0 mol % of Li₂O+Na₂O+K₂O, from 0 to 15 mol % of MgO, from 0 to 15 mol % of CaO, from 0 to 15 mol % of SrO, from 0 to 15 mol % of BaO, 0 mol % or greater and less than 0.050 mol % of As₂O₃, and 0 mol % or greater and less than 0.050 mol % of Sb₂O₃ as glass composition. The reason for limiting the content of each component as described above is as follows. Note that in the description of the content of each component, “%” represents “mol %” unless otherwise indicated.

SiO₂ is a component that forms a glass network. When the content of SiO₂ is too small, chemical resistance deteriorates. In particular, when the content of SiO₂ is too small, the HF etch rate increases; as such, the amount of substrate thickness reduced when etching the glass substrate until the through holes are formed increases, the amount of residue resulting from etching increases, and the taper angle of the through holes increases. In addition, the residue may clog the etching device, reducing productivity. As such, a lower limit amount of SiO₂ is preferably 50%, more preferably 55%, and particularly preferably 60%. Meanwhile, when the content of SiO₂ is too large, the viscosity in high temperature increases, and the amount of heat required when melting increases; this leads to an increased melting cost and a risk of decreased yield due to unmelted raw material for introducing SiO₂. As such, an upper limit amount of SiO₂ is preferably 80%, more preferably 78%, even more preferably 75%, and particularly preferably 70%.

Al₂O₃ is a component that forms a glass network and increases chemical resistance. When the content of Al₂O₃ is too small, chemical resistance decreases, and in particular, the HF etch rate tends to increase. As such, a lower limit amount of Al₂O₃ is preferably 1%, more preferably 3%, even more preferably 5%, and particularly preferably 10%. Meanwhile, when the content of Al₂O₃ is too large, the amount of residue generated according to the amount of substrate thickness reduced during HF etching increases; as such, the taper angle tends to increase, and the residue tends to clog the etching device, reducing productivity. As such, an upper limit amount of Al₂O₃ is preferably 20%, more preferably 18%, and particularly preferably 15%.

B₂O₃ is a component that increases meltability and devitrification resistance. When the content of B₂O₃ is too small, meltability and devitrification resistance tends to decrease, reducing productivity. As such, a lower limit amount of B₂O₃ is preferably 0%, more preferably greater than 0%, even more preferably 0.5%, further more preferably 1%, still more preferably 3%, and particularly preferably 5%. Meanwhile, when the content of B₂O₃ is too large, phase separation of glass tends to occur. When the glass is phase-separated, the transmittance decreases; in addition, cloudiness or unevenness tends to occur on the glass surface during HF etching. As such, an upper limit amount of B₂O₃ is preferably 20%, more preferably 18%, and particularly preferably 15%.

Li₂O, Na₂O and K₂O are components that unavoidably get mixed in from glass raw materials. A total amount of Li₂O, Na₂O and K₂O is from 0 to 1.0%, preferably from 0 to 0.5%, and more preferably from 0 to 0.2%. When the total amount of Li₂O, Na₂O and K₂O is too large, alkali ions may diffuse into a semiconductor material deposited during a heat treatment process.

MgO is a component that improves HF resistance, lowers the viscosity in high temperature, and significantly increases meltability. When the content of MgO is too small, the HF etch rate tends to increase. Furthermore, the meltability of the glass tends to decrease, reducing productivity. As such, a lower limit amount of MgO is preferably 0%, more preferably greater than 0%, and particularly preferably 0.1%. Meanwhile, when the content of MgO is too large, phase separation of glass tends to occur. As such, an upper limit amount of MgO is preferably 15%, more preferably 13%, even more preferably 10%, and particularly preferably 8%.

CaO is a component that lowers the viscosity in high temperature and significantly increases meltability. When the content of CaO is too small, the above effects become hard to obtain. As such, a lower limit amount of CaO is preferably 0%, more preferably greater than 0%, and particularly preferably 0.1%. Meanwhile, when the content of CaO is too large, phase separation of glass tends to occur. As such, an upper limit amount of CaO is preferably 15%, more preferably 13%, even more preferably 10%, and particularly preferably 8%.

SrO is a component that lowers the viscosity in high temperature and increases meltability. When the content of SrO is too small, the above effects become hard to obtain. As such, a lower limit amount of SrO is preferably 0%, more preferably greater than 0%, and particularly preferably 0.1%. Meanwhile, when the content of SrO is too large, phase separation of glass tends to occur. As such, an upper limit amount of SrO is preferably 15%, more preferably 13%, even more preferably 10%, and particularly preferably 8%.

BaO is a component that increases devitrification resistance and makes phase separation of glass difficult. When the content of BaO is too small, the above effects become hard to obtain. As such, a lower limit amount of BaO is preferably 0%, more preferably greater than 0%, and particularly preferably 0.1%. Meanwhile, when a content of BaO is too large, the HF etch rate tends to increase. As such, an upper limit amount of BaO is preferably 15%, more preferably 13%, even more preferably 10%, and particularly preferably 8%.

TiO₂ is a component that lowers the viscosity in high temperature and increases meltability. However, when a large amount of TiO₂ is contained, coloring of glass tends to occur, and the transmittance tends to decrease. As such, especially when the glass substrate is used in a display application, the content of TiO₂ needs to be low, and a range of the content of TiO₂ is preferably 0% or greater and less than 0.2%, more preferably from 0 to 0.1%, even more preferably from 0.0005 to 0.1%, and particularly preferably from 0.005 to 0.1%.

CuO is a component that colors glass and lowers transmittance. As such, especially when the glass substrate is used in a display application, the content of CuO needs to be low, and a range of the content of CuO is preferably 0% or greater and less than 0.2%, more preferably from 0 to 0.1%, and particularly preferably from 0 to 0.05%.

ZnO is a component that increases meltability. However, when a large amount of ZnO is contained, coloring of glass tends to occur, and the transmittance tends to decrease, making it difficult to use the glass substrate in a display application. The content of ZnO is preferably 0% or greater and less than 5%, more preferably from 0 to 3%, even more preferably from 0 to 1%, and particularly preferably from 0 to 0.2%.

In addition to the above components, the following components may be added as an optional component, for example. Note that a total content of other components in addition to the components described above is preferably 10% or less, particularly preferably 5% or less, from the viewpoint of accurately achieving the effects of the present invention.

P₂O₅ is a component that improves HF resistance. However, when a large amount of P₂O₅ is contained, phase separation of glass tends to occur. A content of P₂O₅ is preferably from 0 to 2.5%, more preferably from 0.0005 to 1.5%, even more preferably from 0.001 to 0.5%, and particularly preferably from 0.005 to 0.3%.

Y₂O₃, Nb₂O₅ and La₂O₃ are components that improve mechanical properties such as Young's modulus; however, when a total content and individual content of these components is too large, raw material costs tend to increase. The total content and individual content of Y₂O₃, Nb₂O₅ and La₂O₃ is preferably from 0 to 5%, more preferably from 0 to 1%, even more preferably from 0 to 0.5%, and particularly preferably 0% or greater and less than 0.5%.

SnO₂ is a component that has a good fining action in a high temperature range, and is a component that lowers the viscosity in high temperature and increases meltability. A content of SnO₂ is preferably from 0 to 1%, from 0.001 to 1%, or from 0.01 to 0.5%, and particularly preferably from 0.05 to 0.3%. When the content of SnO₂ is too large, devitrified crystals of SnO₂ are likely to precipitate, which may cause a decrease in yield. Note that when the content of SnO₂ is less than 0.001%, the above effects become hard to obtain.

As mentioned above, SnO₂ is suitable as a fining agent. However, as long as the glass properties are not compromised, up to 5% (preferably up to 1%, particularly preferably up to 0.5%) each of F, SO₃, C, or a metal powder such as Al, Si can be added, instead of SnO₂ or together with SnO₂, as the fining agent. CeO₂ can also be added as a fining agent; however, when a content of CeO₂ is too large, coloring of glass occurs. As such, an upper limit of the content of CeO₂ is preferably 0.1%, more preferably 0.05%, and particularly preferably 0.01%.

As₂O₃ and Sb₂O₃ are also effective as fining agents. However, As₂O₃ and Sb₂O₃ are components that increase the burden to the environment. As such, an alkali-free glass plate according to an embodiment of the present invention preferably does not substantially contain these components, and a range of a content of As₂O₃ and Sb₂O₃ is 0 or greater and less than 0.050%.

Cl is a component that facilitates initial melting of glass batch. Additionally, the addition of Cl can facilitate the action of the fining agent. As a result, it is possible to extend the life of the glass manufacturing kiln while reducing the melting cost. However, when a content of Cl is too large, the strain point tends to decrease; accordingly, when such a glass substrate is used in a display application, issues such as total pitch deviation may occur. As such, the content of Cl is preferably from 0 to 3%, more preferably from 0.0005 to 1%, and particularly preferably from 0.001 to 0.5%. Note that, as a raw material for introducing Cl, a raw material such as a chloride of an alkaline earth metal oxide, an example being strontium chloride, or aluminum chloride can be used.

Fe₂O₃ is a component that unavoidably gets mixed in from glass raw materials and a component that leads to coloring of glass and decrease in transmittance. When a content of Fe₂O₃ is too small, raw material costs tend to increase. Meanwhile, when the content of Fe₂O₃ is too large, the glass substrate is colored and cannot be used in a display application in particular. The content of Fe₂O₃ is preferably from 0 to 300 mass ppm, more preferably from 80 to 250 mass ppm, and particularly preferably from 100 to 200 mass ppm.

Evaluation Method

Next, methods of evaluating the substrate thickness of the glass substrate 100, the hole diameter of the through holes, and the glass shape will be described. The substrate thickness before etching tB of the glass substrate 100, the substrate thickness after etching tA of the glass substrate 100, and the hole diameter Φ1 at the first surface 101 and the second surface 102 can be measured, for example, by a three-dimensional shape measuring device (for example, a CNC three-dimensional measuring device, which is available from Mitutoyo Corporation). Alternatively, the substrate thicknesses and the hole diameter described above may be measured by observing the first surface, the second surface, and a cross section of the glass substrate with a transmission light microscope (for example, ECLIPSE LV100ND, which is available from Nikon Corporation) and performing image processing.

The center-to-center distances of the through holes and the shortest distance among the center-to-center distances can be measured by the following method. The center-to-center distances of the through holes can be determined by determining the center coordinate of each of the through holes at the same time by image processing and determining the distances between the center coordinates of the through holes at the time of the hole diameter measurement described above. The center-to-center distances of the through holes measured using this method are the same as the laser irradiation pitches when forming the modified portions.

Next, whether holes made by etching penetrate through the glass substrate will be confirmed. A scribe is placed on the glass substrate 100 at a position that the through holes 20 will not be exposed at the resulting cross section, and the glass substrate 100 is broken along the scriber, revealing a cross section. Whether the holes penetrate through the glass substrate is confirmed by observing the cross section with a transmission light microscope (for example, ECLIPSE LV100ND, which is available from Nikon Corporation) and moving the focus to the inside of the glass to observe the hole shape. At this time, hole depths from the first surface of the glass substrate and hole depths from the second surface of the glass substrate can be obtained by measuring the distance from the first surface of the glass substrate to the narrowed portion inside the through hole and the distance from the second surface of the glass substrate to the narrowed portion inside the through hole using image processing.

Regarding the glass shape, the lengths of two opposing sides, angles formed by two adjacent sides, and the thickness deviation can be measured, for example, by a three-dimensional shape measuring device (for example, a CNC three-dimensional measuring device, which is available from Mitutoyo Corporation).

The surface roughness Sa at the glass substrate surface of the glass substrate having through holes is a surface roughness based on ISO 25178, and can be measured using a white light interferometer (for example, NewView 7300, which is available from Zygo Corporation).

### MODIFIED EXAMPLE

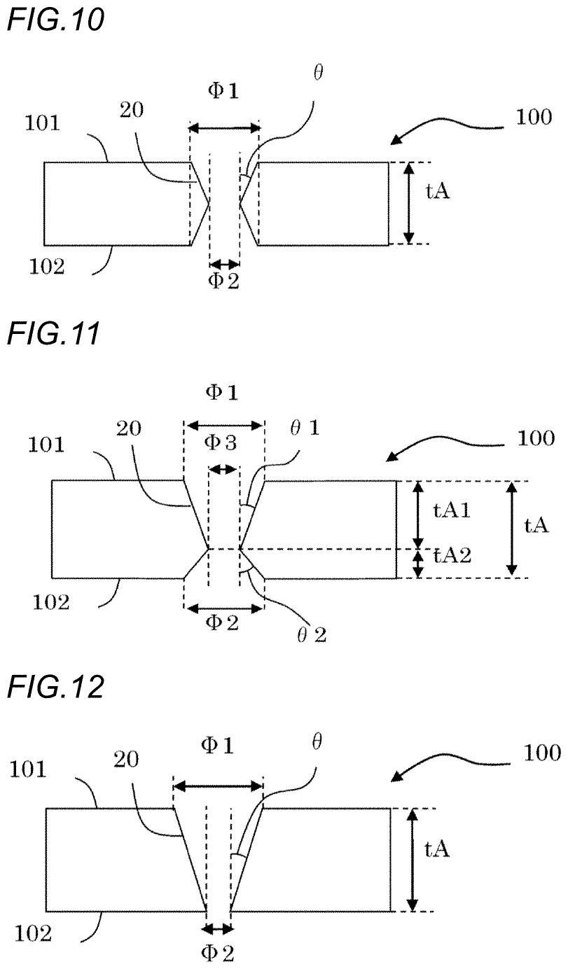

FIG. 10 is a schematic cross-sectional view of a glass substrate having a narrowed portion inside a through hole. Further etching the glass substrate illustrated in FIG. 4 results in a narrowed portion inside a through hole. A taper angle θ can be calculated based on Equation 2 below using a hole diameter Φ1 at the first surface 101 and the second surface 102, a hole diameter Φ2 at the narrowed portion, and a substrate thickness tA.

θ=arctan((Φ1−Φ2)/tA) Equation 2

The hole diameter Φ2 in this case is determined as follows. When observing a cross section according to the evaluation method described above, the focus is moved to the inside of the glass and focused on the through hole 20. The length of the narrowed portion is measured based on this image, and the obtained value is defined as the hole diameter Φ2.

FIG. 11 is a schematic cross-sectional view of a glass substrate in which a narrowed portion inside a through hole is not located at the center portion of a substrate thickness. As illustrated in FIG. 11, the narrowed portion inside a through hole may not be located at the center portion of the substrate thickness. Such through holes can be made by, for example, performing etching on the first surface 101 of the glass substrate 100, and then subsequently performing etching on the second surface 102 opposite to the first surface 101. Taper angles θ1 and θ2 in this case can be calculated based on Equations 3 and 4 below, and a taper angle θ of the through holes can be calculated as an average of θ1 and θ2 based on Equation 5.

θ1=arctan((Φ1−Φ3)/(2*tA1)) Equation 3

θ2=arctan((Φ2−Φ3)/(2*tA2)) Equation 4

θ=(θ1+θ2)/2 Equation 5

FIG. 12 is a schematic cross-sectional view of a glass substrate without a narrowed portion inside a through hole. Through holes as the one illustrated in FIG. 12 can be made by, for example, performing etching only on the first surface 101 of the glass substrate 100. A taper angle in this case can be calculated based on Equation 6 using a hole diameter Φ1 on the first surface 101, a hole diameter Φ2 on the second surface 102, and a substrate thickness tA.

θ=arctan((Φ1−Φ2)/(2*tA)) Equation 6

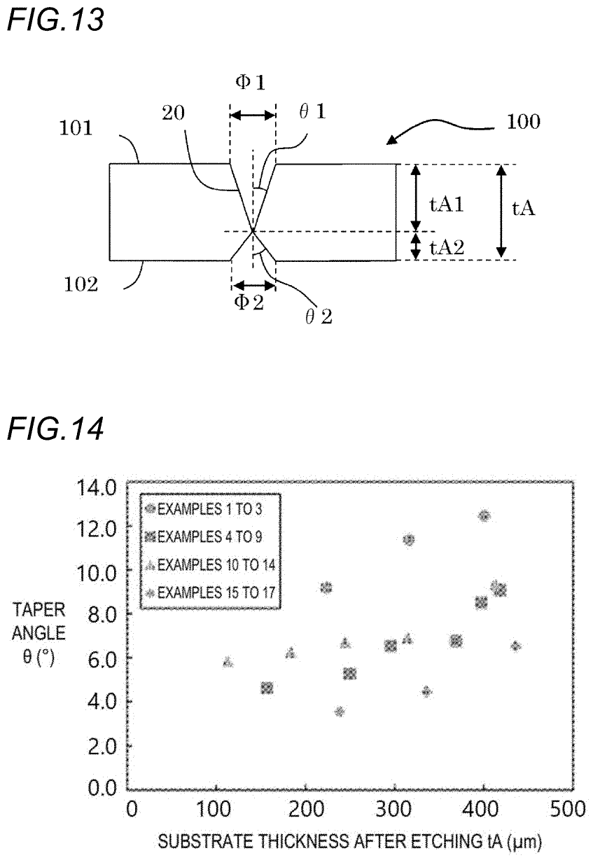

FIG. 13 is a schematic cross-sectional view of a glass substrate, in which a narrowed portion inside a through hole is not located at the center portion of a substrate thickness, immediately after the through hole is formed. Through holes as the one illustrated in FIG. 13 can be made by, for example, moving the laser focal position from the center portion of the glass substrate when viewed from the cross-sectional direction towards the first surface or the second surface of the glass substrate when forming the modified portions using laser irradiation. Taper angles θ1 and θ2 in this case can be calculated based on Equations 7 and 8 below, and a taper angle θ of the through holes can be calculated as an average of θ1 and θ2 based on Equation 5.

θ1=arctan(Φ1/(2*tA1)) Equation 7

θ2=arctan(Φ2/(2*tA2)) Equation 8

### EXAMPLES

Hereinafter, the present invention will be described in detail based on examples, but the present invention is not limited to these examples.

### Example 1

First, an alkali-free glass substrate (product name “OA-11”, which is available from Nippon Electric Glass Co., Ltd.) having a rectangular surface of 40 mm*20 mm and a thickness of 500 μm was prepared. The contents of coloring elements in the glass substrate were 0.01% of TiO₂, 140 mass ppm of Fe₂O₃, and 0% of CuO, CeO₂, and ZnO. The alkali-free glass substrate was polished, resulting in a glass substrate having a thickness of 258 μm.

The glass substrate was irradiated by a picosecond pulse laser shaped into a Bessel beam at a pitch interval of 160 μm, forming approximately 5000 modified portions in a region of 12.8 mm*9.6 mm at the center portion of the glass substrate.

Next, the glass substrate was etched by wet etching until the holes extending from a first surface and a second surface of the glass substrate just penetrated through the glass substrate. The glass substrate was placed in a PP test tube containing an etching liquid, and etching was performed with ultrasonic waves applied to the etching liquid, resulting in a glass substrate having through holes. At this time, a Teflon jig was used to fix the glass substrate with the glass substrate being 40 mm away from the bottom of the test tube. The shape of the through holes made and the shape of the glass substrate were as illustrated in FIG. 4, and the shape parameters were measured by the methods described above using a transmission light microscope (ECLIPSE LV100ND, which is available from Nikon Corporation).

Note that the etching liquid used was a 2.5 mol/L HF solution, and the etching time was set to 30 minutes. The temperature of the etching liquid was set to 20° C. To prevent the temperature from rising during the application of ultrasonic waves, a chiller was used to circulate the water in the ultrasonic device and keep the water temperature at 20° C. In addition, an ultrasonic cleaner (VS-100III, which is available from AS ONE Corporation) was used to apply ultrasonic waves. Using this ultrasonic cleaner, ultrasonic waves of 28 kHz were applied to the etching liquid.

### Example 2

A glass substrate having through holes was obtained by the same method as in Example 1 except that the substrate thickness of the glass substrate before etching was changed to 388 μm and the etching time was changed to 60 minutes.

### Example 3

A glass substrate having through holes was obtained by the same method as in Example 1 except that the substrate thickness of the glass substrate before etching was changed to 500 μm and the etching time was changed to 85 minutes.

Table 1 presents the results of measuring the substrate thickness, hole diameter, and taper angle of Examples 1 to 3 using the methods described above.

TABLE 1

| | Substrate Thickness | Substrate Thickness | Amount of Substrate | Hole | Taper |
|---|---|---|---|---|---|
| | Before Etching | After Etching | Thickness Reduced | Diameter | Angle |
| | tB (μm) | tA (μm) | Δt (μm) | Φ1 (μm) | θ (°) |
| Example 1 | 258 | 223 | 35 | 36 | 9 |
| Example 2 | 388 | 316 | 72 | 64 | 11 |
| Example 3 | 500 | 400 | 100 | 89 | 13 |

From Table 1, it is clear that the smaller the substrate thickness before etching or the smaller the substrate thickness after etching, the smaller the taper angle.

The values of (amount of substrate thickness reduced by etching Δt)/(substrate thickness before etching tB) and the values of the taper angles in Examples 1 to 3 are presented in Table 2.

TABLE 2

| | Examples | | |
|---|---|---|---|
| | 1 | 2 | 3 |
| Glass Substrate | OA-11 | OA-11 | OA-11 |
| (Amount of Substrate Thickness Reduced | 0.136 | 0.186 | 0.200 |
| Δt/Substrate Thickness Before Etching TB) | | | |
| Taper Angle θ (°) | 9 | 11 | 13 |

From Table 2, it is clear that the smaller the value of (amount of substrate thickness reduced by etching Δt)/(substrate thickness before etching tB), the smaller the taper angle.

### Examples 4 to 17

In order to confirm the influence of the type of glass substrate, alkali-free glass substrates “OA-11” and “OA-31”, available from Nippon Electric Glass Co., Ltd., as well as alkali-containing glass substrates “BDA”, available from Nippon Electric Glass Co., Ltd., were prepared. The contents of coloring elements in OA-31 were 0.003% of TiO₂, 90 mass ppm of Fe₂O₃, and 0% of CuO, CeO₂, and ZnO. The contents of coloring elements in BDA were 0.0θ1% of TiO₂, 0.72% of ZnO, 10 mass ppm of Fe₂O₃, and 0% of CuO and CeO₂. Glass substrates having through holes were obtained by the same conditions and methods as in Examples 1 to 3, except for the type of etching liquid and the temperature of the etching liquid, which will be described below.

The etching liquid used was a mixed acid of 2.5 mol/L HF and 1.0 mol/L HCl solution, and the temperature of the etching liquid was set to 30° C. To prevent the temperature from rising during the application of ultrasonic waves, a chiller was used to circulate the water in the ultrasonic device and keep the water temperature at 30° C.

The shape of the through holes made and the shape of the glass substrate were as illustrated in FIG. 13, and the shape parameters were measured by the methods described above using a transmission light microscope (ECLIPSE LV100ND, which is available from Nikon Corporation). The surface roughness Sa of the glass substrates was measured using NewView 7300, which is available from Zygo Corporation. As the measurement area, a substantially center portion of one mesh arbitrarily extracted from meshes composed of line segments connecting the center coordinates of the through holes was selected. The measurement conditions were a 50× objective lens, a 1× zoom lens, 8 integration times, and a camera pixel count of 640×480. The surface roughness Sa was calculated using a 50×50 μm area in the substantially center portion of a 140×105 μm observation field. For the image processing conditions, “Shape Removal” was set to “plane”, “Filter” was set to “Band Pass”, “Filter Type” was set to “Gauss Spline”, the value of “L filter” was set to 26.00 μm, and the value of “S Filter” was set to 0.66 μm.

Table 3 presents the thickness of the glass substrates prepared, the shape of the through holes made by etching, and the shape of the glass substrates after etching. FIG. 14 illustrates a relationship between the substrate thickness and the taper angle in the glass substrate having through holes.

TABLE 3

| | Examples | | | | | | |
|---|---|---|---|---|---|---|---|
| | 4 | 5 | 6 | 7 | 8 | 9 | 10 |
| Glass Substrate | OA-11 | OA-11 | OA-11 | OA-11 | OA-11 | OA-11 | OA-31 |
| Etching Time (min) | 5 | 10 | 15 | 20 | 30 | 33 | 5 |
| Substrate Thickness Before Etching | 170 | 275 | 338 | 425 | 471 | 500 | 121 |
| tB (μm) | | | | | | | |
| Substrate Thickness After Etching | 157 | 249 | 295 | 368 | 396 | 417 | 113 |
| tA (μm) | | | | | | | |
| Amount of Substrate Thickness Reduced | 13 | 25 | 43 | 57 | 75 | 83 | 8 |
| Δt (μm) | | | | | | | |
| Δt/tB | 0.077 | 0.092 | 0.127 | 0.135 | 0.159 | 0.166 | 0.068 |
| Hole Diameter Φ1 (μm) | 14 | 25 | 35 | 45 | 56 | 68 | 11 |
| Hole Diameter Φ2 (μm) | 13 | 23 | 35 | 44 | 66 | 66 | 12 |
| Hole Depth tA1 (μm) | 86 | 129 | 150 | 199 | 197 | 212 | 59 |
| Hole Depth tA2 (μm) | 71 | 121 | 145 | 169 | 200 | 205 | 54 |
| Taper Angle θ1 (º) | 4.3 | 5.3 | 6.5 | 6.2 | 7.9 | 9.1 | 5.4 |
| Taper Angle θ2 (º) | 5.0 | 5.3 | 6.6 | 7.3 | 9.2 | 9.1 | 6.3 |
| Taper Angle θ (º) | 4.7 | 5.3 | 6.6 | 6.8 | 8.5 | 9.1 | 5.9 |
| ((θ1 + θ2)/2) | | | | | | | |
| Surface Roughness Sa (nm) | Not measured | Not measured | Not measured | Not measured | Not measured | Not measured | 0.180 |
| | 11 | 12 | 13 | 14 | 15 | 16 | 17 |
| Glass Substrate | OA-31 | OA-31 | OA-31 | OA-31 | BDA | BDA | BDA |
| Etching Time (min) | 10 | 15 | 20 | 35 | 10 | 20 | 40 |
| Substrate Thickness Before Etching | 202 | 274 | 355 | 500 | 258 | 367 | 500 |
| tB (μm) | | | | | | | |
| Substrate Thickness After Etching | 183 | 244 | 314 | 412 | 238 | 336 | 436 |
| tA (μm) | | | | | | | |
| Amount of Substrate Thickness Reduced | 18 | 30 | 40 | 88 | 20 | 31 | 64 |
| Δt (μm) | | | | | | | |
| Δt/tB | 0.092 | 0.109 | 0.113 | 0.176 | 0.076 | 0.084 | 0.128 |
| Hole Diameter Φ1 (μm) | 20 | 28 | 38 | 68 | 15 | 26 | 50 |
| Hole Diameter Φ2 (μm) | 20 | 29 | 38 | 68 | 15 | 26 | 49 |
| Hole Depth tA1 (μm) | 97 | 131 | 168 | 206 | 132 | 185 | 236 |
| Hole Depth tA2 (μm) | 86 | 113 | 146 | 206 | 106 | 151 | 200 |
| Taper Angle θ1 (º) | 5.8 | 6.2 | 6.5 | 9.3 | 3.2 | 4.0 | 6.1 |
| Taper Angle θ2 (º) | 6.7 | 7.2 | 7.4 | 9.4 | 3.9 | 4.9 | 7.0 |
| Taper Angle θ (º) | 6.3 | 6.7 | 6.9 | 9.4 | 3.6 | 4.5 | 6.5 |
| ((θ1 + θ2)/2) | | | | | | | |
| Surface Roughness Sa (nm) | 0.193 | 0.270 | 0.304 | 0.478 | Not measured | Not measured | Not measured |

From FIG. 14, it was found that the taper angle can be reduced by reducing the substrate thickness of the glass substrate having through holes, regardless of the type of glass. Furthermore, by comparing Examples 1 to 3 with Examples 4 to 9, it was found that the taper angle can be reduced by optimizing the etching conditions.

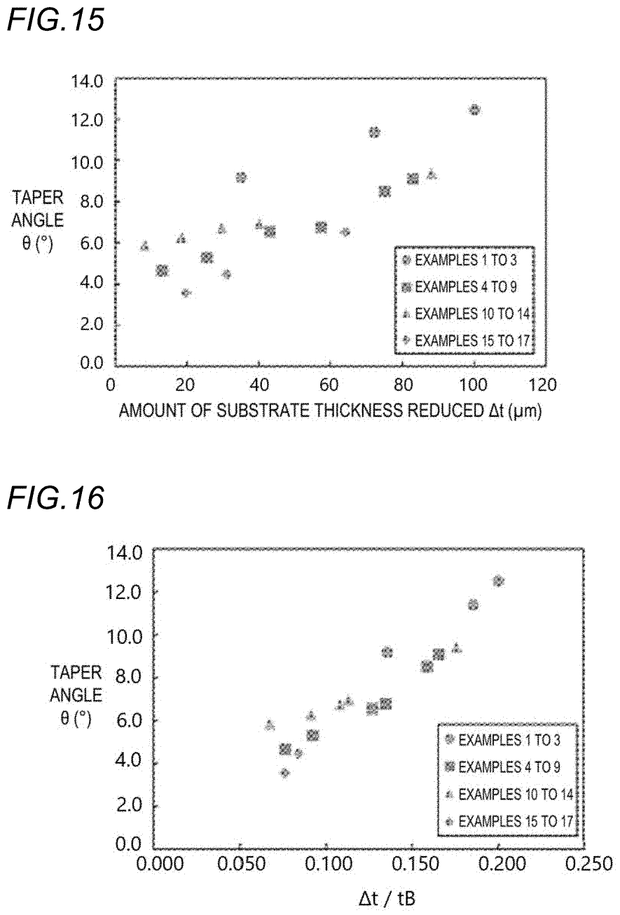

Furthermore, FIG. 15 illustrates a relationship between the amount of substrate thickness reduced by etching Δt and the taper angle, and FIG. 16 illustrates a relationship between the value of (amount of substrate thickness reduced by etching Δt)/(substrate thickness before etching tB) and the taper angle.

From this, it was found that the taper angle can be reduced by reducing the amount of substrate thickness reduced by etching Δt, or by reducing the value of (amount of substrate thickness reduced by etching Δt)/(substrate thickness before etching tB).

### Examples 18 to 23

In order to confirm the influence of the center-to-center distances, glass substrates before etching that are the same as the one in Example 11 were prepared, and modified portions were made with the laser irradiation pitches during the making of the modified portions on the glass substrates changed to the conditions presented in Table 4. The glass substrates were etched under the same conditions and method as in Example 11, resulting in glass substrates immediately after formation of through holes. In each of the examples, the center-to-center distances of the formed through holes were the same as the laser irradiation pitch. In Examples 18 to 23, the values of the hole diameter and the taper angle of the through holes were the same as the values in Example 11. From these results, it was found that reducing the substrate thickness before etching can reduce the hole diameter of the through holes and can shorten the center-to-center distances between the through holes. In addition, it was not confirmed that shortening the center-to-center distances between the through holes affected the shape of the through holes.

TABLE 4

| | Examples | | | | | | |
|---|---|---|---|---|---|---|---|
| | 11 | 18 | 19 | 20 | 21 | 22 | 23 |
| Glass Substrate | OA-31 | OA-31 | OA-31 | OA-31 | OA-31 | OA-31 | OA-31 |
| Laser Irradiation Pitch (Δm) | 160 | 200 | 100 | 50 | 40 | 35 | 30 |

### REFERENCE SIGNS LIST

100 Glass substrate
20 Through hole
21 Non-through hole
101 First surface
100 Second surface
120 Modified portion

1: A glass substrate having a substrate thickness of from 0.10 mm to 0.50 mm and having two or more through holes,
the through holes having a taper angle of from 0° to 13° and
a shortest distance among center-to-center distances between the through holes being 200 μm or less.

2: The glass substrate according to claim 1, wherein the shortest distance among the center-to-center distances between the through holes is greater than 1.2 times a sum of radii of two through holes with the shortest center-to-center distance.

3: The glass substrate according to claim 1, wherein the glass substrate has at least one through hole having a hole diameter of from 1 μm to 100 μm.

4: The glass substrate according to claim 1, comprising 0 mol % or greater and less than 0.2 mol % of TiO₂, 0 mol % or greater and less than 0.2 mol % of CuO, and 0 mol % or greater and less than 5 mol % of ZnO as glass composition.

5: The glass substrate according to claim 1, wherein the glass substrate is a low-alkali glass.

6: The glass substrate according to am claim 1, comprising from 50 to 80 mol % of SiO₂, from 1 to 20 mol % of Al₂O₃, from 0 to 20 mol % of B₂O₃, from 0 to 1.0 mol % of Li₂O+Na₂O+K₂O, from 0 to 15 mol % of MgO, from 0 to 15 mol % of CaO, from 0 to 15 mol % of SrO, from 0 to 15 mol % of BaO, 0 mol % or greater and less than 0.050 mol % of As₂O₃, and 0 mol % or greater and less than 0.050 mol % of Sb₂O₃ as glass composition.

7: A method for manufacturing a glass substrate, comprising:
forming two or more modified portions on a glass substrate using laser irradiation, and then
removing the modified portions by etching, in a manner that a substrate thickness of the glass substrate is reduced by from 1 to 100 μm, to form two or more through holes having a taper angle of from 0° to 13°.

8: A method for manufacturing a glass substrate, comprising:
forming two or more modified portions on a glass substrate using laser irradiation, and then
removing the modified portions by etching, in a manner that the glass substrate has: (amount of substrate thickness reduced by etching)/(substrate thickness before etching) of 0.200 or less, to form two or more through holes having a taper angle of from 0° to 13°.
